(19) United States
(12) Patent Application Publication
(10) Pub. No.: US 2007/0234422 A1
(43) Pub. Date: Oct. 4, 2007

(54) Authentication of Applications

(75) Inventor: Jonathan R. Piesing, Croydon (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,613

(22) PCT Filed: May 25, 2005
(86) PCT No.: PCT/IB05/51710

§ 371 Date: Nov. 27, 2006

(30) Foreign Application Priority Data
May 27, 2004 (GB) 0411861.8

(51) Int. Cl. H04L 9/32

(52) U.S. Cl. 726/19

(57) ABSTRACT

A method for selecting a certificate for the authentication of an application associated with a distributor, the method comprising accessing (104) application metadata comprising an identifier (108) of the distributor and extracting (106) the identifier, receiving (110) certificates comprising one or more identifiers (114) of respective distributors and extracting (112) these identifiers, and then selecting (120) a certificate based on a comparison (116) of the identifiers extracted from the application metadata and the certificates. The association of an identifier with a distributor is managed so that certificates can only be used to authenticate applications distributed by identified distributors. In the context of digital TV, the Digital Video Broadcasting (DVB®) Project performs this management task through the use of DVB Network IDs to identify distributors which are included in the extension data of the certificates as well as within the application metadata.

The present invention relates to authentication of applications, and in particular to authentication of applications associated with a particular distributor.

The Digital Video Broadcasting (DVB®) Project (www.dvb.org) is developing standards such as Multimedia Home Platform (MHP®) which allow interactive applications to be developed and distributed independently of mainstream digital content whilst being accessible to end users by being run on standardised consumer devices such as set top boxes, integrated digital TVs and the like. There is a growing trend in consumer electronics products to require that interactive application code be authenticated before use. In the US OpenCable specification, this code is the manufacturer's software in the TV or set-top box. In MHP and the US OpenCable Applications Platform (OCAP), this code is externally developed Java applications. A key part of code authentication schemes is the use of Public Key Infrastructure (PKI) to identify the source of the code being authenticated.

Consequently, the MHP and OCAP standards have adopted PKI to support the signing and authentication of interactive TV applications. The mechanisms for this are based on those used in the internet for secure WWW sites. In these mechanisms, signing and authentication relies on information packaged in units called “certificates” (issued by “certificate authorities”) containing information to authenticate data as well as to identify the entity to whom the certificate was issued.

In the internet, a certificate may identify a specific WWW site for which it may be used and certificate authorities are responsible for ensuring that an applicant for a certificate which identifies a specific WWW site is a proper representative of the organisation owning that WWW site. Hence the diligence of certificate authorities to validate organisations is important in maintaining the required level of trust in the system. Furthermore, usage of an issued certificate is restricted to those Website domains operated by the approved organisation.

In the context of MHP and OCAP, certificates are intended to be used for specified purposes, for example to authenticate a specified interactive TV application. The MHP specification is silent regarding to whom certificates will be issued. Appropriate organisations could for example be TV broadcasters, since these are more able to pay for certificates and hence to contribute to the cost of operating the PKI system. However, usage of an issued certificate is not restricted to the market or markets in which the operator is active. A certificate issued to sign MHP applications in one market could in addition, or alternatively, be used to sign MHP applications in another market. This may not correspond to the intention of the issuer of the certificate.

The document entitled “Certificate Extensions and Attributes Supporting Authentication in PPP and Wireless LAN” (by Housley, R. et al, PKIX Working Group, March 2004) discloses automated selection of certificates for Wireless Local Area Network (WLAN) IEEE 802.1x clients by using certificate extensions. Each IEEE 802.11 WLAN has a different network name, called Service Set Identifier (SSID). If the networks do not have a roaming agreement, then the IEEE 802.1x client needs to select a certificate for the current network environment. Including a list of SSIDs in a certificate extension facilitates automated selection of an appropriate X.509 public key certificate. The Wireless LAN (WLAN) System Service identifiers (SSIDs) public key certificate extension contains a list of SSIDs. When more than one certificate indicates that the certified public key is appropriate for use in the LAN environment, then the list of SSIDs may be used to select the correct certificate for authentication in a particular WLAN. However, the document acknowledges that since SSID values are unmanaged, the same SSID can appear in different certificates that are intended to be used with different WLANs (for example each run by a different operator or provider). When this occurs, automatic selection of the certificate will fail.

It is an object of the present invention to provide an improved method of selecting a certificate for an application.

In accordance with the present invention there is provided a method for selecting a certificate for the authentication of an application associated with a distributor, the method comprising:
accessing application metadata, which metadata comprises an identifier of the distributor;
extracting the identifier from the application metadata;
receiving certificates, each certificate comprising one or more identifiers of respective distributors;
extracting the identifiers from the certificates; and
selecting a certificate based on a comparison of the identifiers extracted from the application metadata and the certificates;
   wherein, the association of an identifier with a distributor is managed.

Advantageously, the managed association of identifiers with distributors ensures that certificates can only be used to authenticate applications distributed by identified distributors. The term ‘application’ is used herein to refer to software-based informational, productivity or entertainment services provided in the form of modules or programs intended to run standalone or in conjunction with another service or services. The term ‘distributor’ includes entities such as broadcasters, network operators and service providers. Such entities distribute applications to various types of markets, such as national or regional populations, a group of subscribers and the like. The term ‘managed’ in relation to the identifiers means that the determination and utilisation of the identifiers is not ad-hoc; rather, control is by an authority to ensure that identifiers, and therefore distributors and their applications, are distinguishable one from another. The application itself can be intended for (distributed to) more than one market by containing the corresponding identifiers. Furthermore, a single certificate can serve a plurality of markets (distributors) by containing the corresponding identifiers for those markets. More than one certificate may be available to sign an application; in this case the method is free to select any one of those which correspond. This enables a certificate authority to provide specific services for specific distributors or for those organisations distributing applications via a specific distributor.

For existing schemes such as MHP and OCAP, advantageously the method can employ existing identifiers which are already managed, thereby saving cost. In the case of MHP, the identifiers are preferably managed by the Digital Video Broadcasting (DVB) Project, the identifier comprising the DVB Network ID issued to a respective distributor. The term ‘Network ID’ is used herein to refer to the DVB entity ‘network_ID’ and/or entity ‘original_network_ID’ as defined in ETSI ETR 101 162: “Digital Video Broadcasting (DVB); Allocation of Service Information (SI) codes for DVB systems” and ETSI EN 300 468 “Digital Video Broadcasting (DVB); Specification for Service Information (SI) in DVB Systems”. Advantageously, use of the DVB Network ID as an identifier of the distributor couples authentication of applications to the operational functioning of the DVB network itself, which makes such an authentication mechanism very difficult to circumvent. Applications authorised by certificates selected according to the present invention may be any suitable informational, productivity or entertainment application. An example of the latter includes a Digital Video Broadcasting compliant application in which the Service Information of the associated DVB service comprises the application metadata (comprising identifiers for at least one distributor).

According to a further aspect of the present invention, there is provided a system for selecting a certificate for the authentication of an application associated with a distributor comprising:
a first server and at least one receiver, the first server operable to send certificates to the at least one receiver;
   wherein the at least one receiver is operable to:
access application metadata, which metadata comprises an identifier of the distributor;
extract the identifier from the application metadata;
receive certificates, each certificate comprising one or more identifiers of respective distributors;
extract the identifiers from the certificates; and
select a certificate based on a comparison of the identifiers extracted from the application metadata and the certificates.

Advantageously, the distribution of certificates can be independent of the distribution of applications and associated application metadata. In one example, an application (and its metadata) may be already resident at or in a receiver (for example on a portable record carrier such as an optical disc, or in non-volatile storage within the receiver); authentication of the application being then dependent on the receipt of a suitable certificate. The certificate may be forwarded to the receiver using any suitable wired or wireless distribution method, including for example, broadcast TV/radio (via terrestrial, cable and/or satellite) or computerised network (Internet via dial-up PSTN/xDSL, Ethernet, WiFi, GSM/GPRS). In another example, the application metadata may also be sent to the receiver, using any suitable method from those listed above. Although distribution of application metadata is typically coupled with the distribution of the application itself, this is not essential to the operation of the method. The application metadata and certificate(s) may be distributed using the same distribution mechanism (for example where both are carried in the same DVB multiplex); such a scenario is particularly suited to the case where a server is configured to provide both application metadata and certificate(s). Alternatively, application metadata and certificate(s) may be distributed using different methods (e.g. application metadata via broadcast transmission; certificates via the Internet). In this case, different servers may be used to respectively send application metadata and certificate(s).

According to a yet further aspect of the present invention, there is provided a receiver for use in the system comprising:
a store operable to store application metadata;
a first input device operable to receive certificates;
a processor comprising a CPU interconnected to a program store and a data store, the processor configured to:
   access application metadata, which metadata comprises an identifier of the distributor;
   extract the identifier from the application metadata;
   receive certificates, each certificate comprising one or more identifiers of respective distributors;
   extract the identifiers from the certificates; and
   select a certificate based on a comparison of the identifiers extracted from the application metadata and the certificates.

Advantageously, the receiver can be independent of or combined with the entity which executes the application authenticated by the selected certificate, an example of the latter being a set top box. The receiver may already have access to the application metadata, for example from local storage, and therefore receives certificates via an input device. Examples of suitable input devices include a tuner in the case where certificates are distributed using broadcast media, or a network interface (for example a modem, Ethernet card, WiFi interface, IrDA port, etc.) where certificates are distributed via a computer network (for example the Internet) or a media reader where certificates are distributed using physical media. Alternatively, the receiver may also receive the application metadata (and optionally also the corresponding application) via the same input device used for receiving certificates. Alternatively, a separate input device is used to receive the application metadata. For interactive TV applications, the application metadata is preferably received using a DVB compliant tuner.

Embodiments of the invention will now be described, by way of example only, with reference to the accompanying drawings in which:

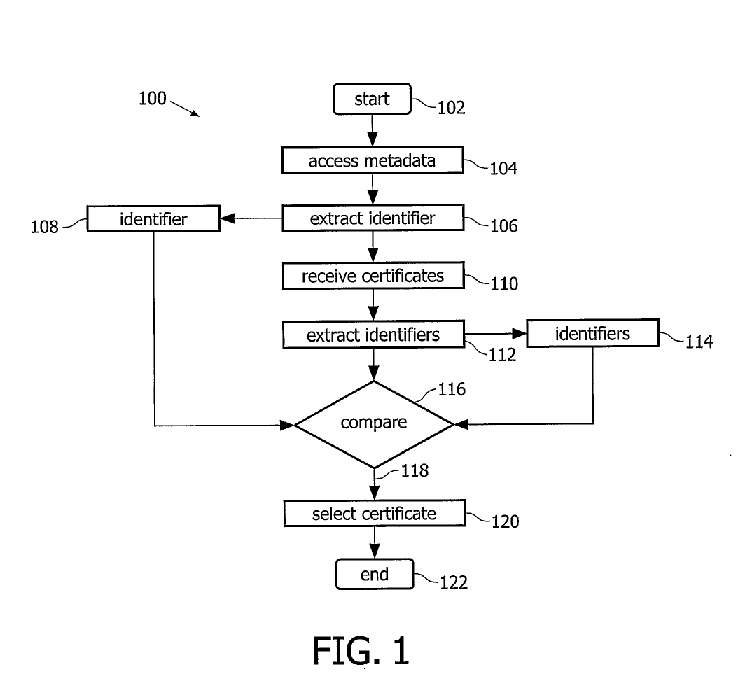

FIG. 1 shows a method for selecting a certificate for authentication of an application associated with a distributor;

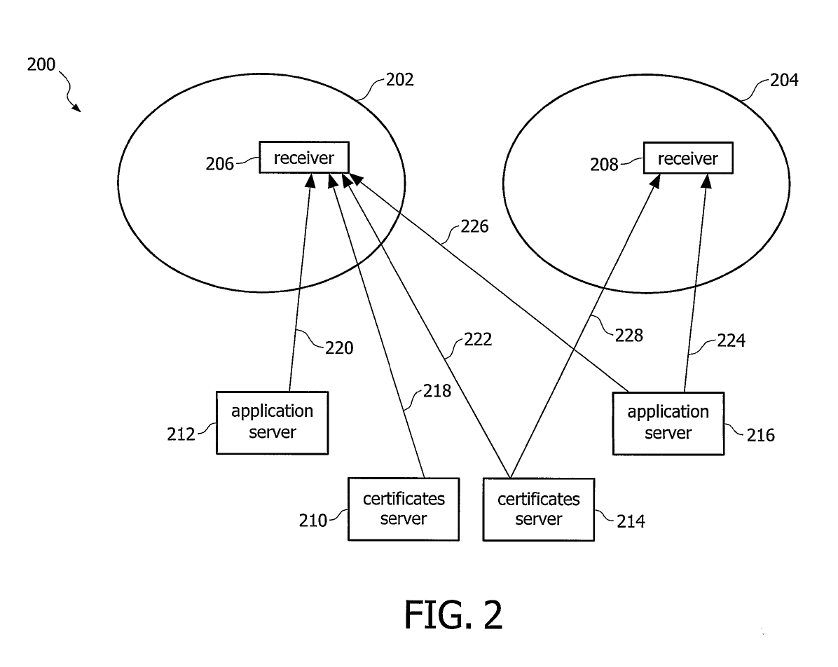

FIG. 2 shows a system for selecting a certificate for authentication of an application associated with a distributor;

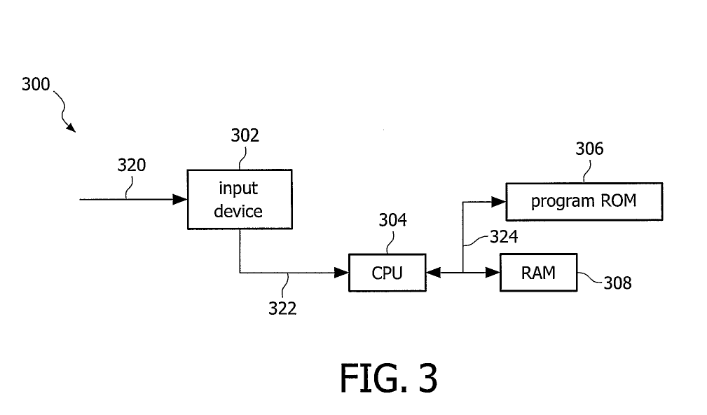

FIG. 3 shows a receiver for selecting a certificate for authentication of an application associated with a distributor; and

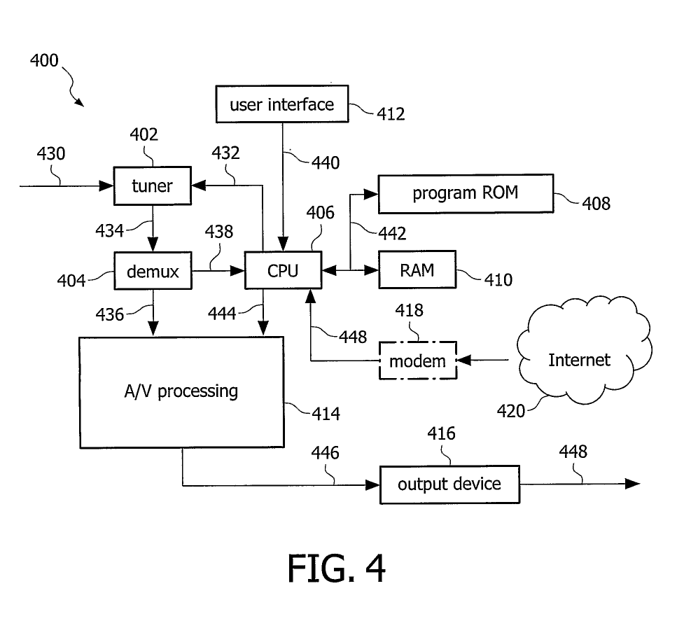

FIG. 4 shows the functional components of a set top box for selecting a certificate for authentication of an application associated with a distributor.

FIG. 1 shows a method, shown generally at 100, for selecting a certificate for authentication of an application associated with a distributor. The method starts at 102 and proceeds to access 104 metadata of an application. Metadata of an application typically comprises technical data related to the application such as the location of components of the application within the transmission multiplex. In relation to the present invention, the metadata also includes an identifier indicating the distributor of the application. Any suitable distributor identifier may be used, including in respect of the application any of: an author/creator, a licensor, a network operator or a medium used to distribute the application. A pre-requisite of a suitable distributor identifier is that it is managed (as discussed earlier). One or more such identifiers may be associated with the application (and therefore included within its metadata), such that authorisation of an application may be dependent on matching one or a combination of the identifiers, as discussed further below. In the context of a DVB compliant application, the metadata of the application comprises one or more Network IDs in the Service Information (SI) data which, for the purpose of the present invention, also serve as distributor identifiers. Other parameters defined within DVB may be eligible to serve as distributor identifiers either exclusively or in combination with Network IDs, for example data identifying the delivery system (terrestrial, cable, satellite, and the like). Other distributor identifier schemes are also supported by the present invention. As an example, for an application distributed using DVD, the corresponding metadata (on the DVD, or sent via other means) might comprise data identifying the physical distributor (e.g. a film distributor, a retailer). Provided the identification scheme is managed then the present invention supports this and other types of physical distribution; one example is to use an existing managed coding scheme, such as the manufacturer identification number utilised in UPC/EAN bar-coding.

Metadata of an application, distributed independently or in conjunction with the application itself, may be read from removable media such as magnetic/optical disk, solid state storage, or from non-volatile storage internal to the device or product hosting the application, such as hard disk or solid state storage. The metadata and/or its application may be factory programmed; typically, it is downloaded to the device or product hosting the application, for example via local wired or wireless LAN, Internet or broadcast.

The method extracts 106 one or more identifiers 108 from the metadata, for example by parsing, and then receives 110 certificates for authenticating the application. Any suitable certificate type may be used, providing it has the ability to also convey identifiers for at least one distributor. Preferably, an adapted existing certification scheme is employed, for example using certificates specified according to the Internet X.509 Public Key Infrastructure Certificate and CRL profile and including extension data comprising identifiers for at least one distributor. This particular scheme is described in document RFC 2459—“Internet X.509 Public Key Infrastructure. Certificate and CRL Profile”, IETF, January 1999. Each certificate comprises one or more identifiers each identifying a respective distributor. The method then extracts 112 the identifiers 114 from the certificates. The one or more identifiers 108 from the application metadata are then compared 116 with the identifiers 114 from the received certificates. The result 118 of the comparison determines whether a certificate is selected 120, such determination being application dependent. In the example of a DVB compliant application, selection of a certificate occurs if, and only if, an identifier from the application metadata matches an identifier from the certificate. Where the result of comparison indicates that a certificate does not comprise a matching identifier, then such a certificate is rejected. For applications in general, where application metadata includes more than one identifier, a certificate may be selected on the basis that it comprises one, some, or all, matching identifiers, according to pre-determined conditions for example as specified by the distributor. The method ends at 122.

FIG. 2 shows a system, shown generally at 200, for selecting a certificate for authentication of an application associated with a distributor. The system comprises a server 210 which sends certificates 218 to a receiver 206 of a population (or market) of receivers, as denoted by 202. The server 210 may reside in a network (including the Internet), and communicate with the receiver via a local (wired or wireless) area network (LAN) connected using for example Ethernet, WiFi, Infrared, or the like; and/or a wide area network connected using for example PSTN/xDSL modem, GSM, PCS, GPRS, or the like. Alternatively, or in addition, the server may communicate using a data service provided within a broadcast distribution, such as DVB-T, DVB-S or DVB-C. A yet further alternative, is that certificates are delivered to the receiver using physical media rather than from a server, for example CD-ROM, DVD, floppy disk or the like; however, distribution of certificates in this way is not preferred.

The receiver 206 can receive certificates from more than one server, as shown by servers 210, 214. The receiver 206 accesses application metadata which may be available within the receiver itself; typically, new or updated applications can be also be provided by application server 212, 216 which in the example depicted also provide the respective metadata 220, 226. As discussed earlier, in respect of a particular application the receiver compares the distributor identifiers obtained from the application metadata with those obtained from the received certificates to determine a suitable certificate to select to authenticate the application. As shown in FIG. 2, a certificates server 214 or application server 216 can serve different receiver populations 202, 204 (markets) comprising receivers 206, 208 with respective certificates 222, 228 and respective metadata 226, 224. It should be noted that the distribution paths taken by metadata and certificates are irrelevant to the comparison to select the certificate to authenticate the corresponding application; it is the identifiers obtained from the metadata and certificates that determine such selection. Therefore, in the example of FIG. 2, server 210 could provide receiver 206 with certificates 218 relevant to application metadata 226 provided by server 216, the application itself residing in receiver 206 or provided by either server 212 or server 216.

As the skilled person will recognise, a server described above could be capable of providing to a receiver any combination of certificates, application metadata and applications. Clearly, in an exemplary digital TV system based on DVB, one arrangement would be for a DVB registered operator to distribute certificates, application metadata and applications using the existing broadcast TV distribution network. As an alternative, any of these could be distributed using alternative, preferably existing, distribution mechanisms such as broadcast radio, the Internet, or mobile phone networks.

FIG. 3 shows a receiver, shown generally at 300, for selecting a certificate for authentication of an application associated with a distributor. The receiver comprises an input device 302 which receives data comprising certificates 320 from a source such as server on a network, as described above in relation to FIG. 2. Examples of input devices include a tuner (for example DVB tuner, DAB tuner, broadcast analogue TV tuner for VBI data, broadcast analogue FM radio for RDS data), modem (for example PSTN-Hayes, xDSL, cable), network interface unit (for example Ethernet, WiFi, HiperLAN, IrDA, GSM, GPRS, PCS). In the case where certificates are distributed using physical media, input device 302 is a media reader such as a floppy disk drive, optical disk drive or the like. The input device may be part of another host system such as a PC, cable TV box, set top box or the like. A processor, comprising CPU 304 interconnected 324 in known fashion with non-volatile storage (for example program ROM 306) and data memory (for example RAM 308), receives certificates 322 from the input device 302. Alternative arrangements for the processor are readily identifiable to the skilled person. In some cases, certificates may be already resident in the non-volatile storage, but in general, certificates will be received from a source external to the receiver. In the example of FIG. 3, applications and associated metadata may be already resident within the receiver in non-volatile storage 306, 308; alternatively, one or both may also be received via the input device 302 from a network or physical media. Alternatively, application metadata may be received using a further input device, as discussed in more detail below in relation to FIG. 4. In any case, the processor obtains identifiers from the metadata and certificates and selects a certificate based on a comparison of the identifiers.

FIG. 4 shows the functional components of a set top box, shown generally at 400, for selecting a certificate for authentication of an application associated with a distributor. The set top box comprises a DVB tuner 402 which receives broadcast transmissions 430, from a DVB compliant satellite, terrestrial or cable network, as is known in the art. A processor, comprising CPU 406 interconnected 442 with non-volatile storage (for example program ROM 408) and data memory (for example RAM 410) controls 432 the tuner 402 according to user commands 440 from user interface 412 to select services and applications obtainable from the DVB network. Data 434 received by the tuner is demultiplexed 404 into its corresponding primary service (for example TV programme) AV content 436 and secondary service content 438.

By way of example, a secondary service can comprise an interactive application designed to complement the primary service content such as an interactive advertisement. In such an example, secondary service content 438 may comprise only certificates to authenticate an interactive application already resident within or available to the set top box. Optionally, the certificates may be received using a separate input device such as modem 418 which is able to receive the certificates 448 from a computer network such as the Internet 420. However, more generally, interactive applications are downloadable, for example from the DVB network and secondary service content 438 then comprises applications and associated metadata and typically also the certificates. The processor then obtains the distributor identifiers from the metadata and certificates, selects a suitable certificate and then authenticates and runs the relevant interactive application. AV content output 444 from the interactive application is then applied to AV processing block 414 to be combined with primary service AV content 436 according to the requirements of the interactive application. The AV processing block 414 then passes processed AV signals 446 to output device 416 which then forwards 448 them for rendering using suitable display and audio devices.

Clearly, the present invention also supports the case in which service content 438 is independent of any primary service content, for example service content 438 comprising games, productivity software programs, and the like.

The foregoing method and implementations are presented by way of examples only and represent a selection of a range of methods and implementations that can readily be identified by a person skilled in the art to exploit the advantages of the present invention.

In the description above and with reference to FIG. 1, there is provided a method for selecting a certificate for the authentication of an application associated with a distributor, the method comprising accessing 104 application metadata comprising an identifier 108 of the distributor and extracting 106 the identifier, receiving 110 certificates comprising one or more identifiers 114 of respective distributors and extracting 112 these identifiers, and then selecting 120 a certificate based on a comparison 116 of the identifiers extracted from the application metadata and the certificates. The association of an identifier with a distributor is managed so that certificates can only be used to authenticate applications distributed by identified distributors. In the context of digital TV, the Digital Video Broadcasting (DVB®) Project performs this management task through the use of DVB Network IDs to identify distributors which are included in the extension data of the certificates as well as within the application metadata.

1. A method for selecting a certificate for the authentication of an application associated with a distributor, the method comprising:
accessing application metadata, which metadata comprises an identifier of the distributor;
extracting the identifier from the application metadata;
receiving certificates, each certificate comprising one or more identifiers of respective distributors;
extracting the identifiers from the certificates; and
selecting a certificate based on a comparison of the identifiers extracted from the application metadata and the certificates;
wherein, the association of an identifier with a distributor is managed.

2. A method as claimed in claim 1, wherein the certificate is specified according to the Internet X.509 Public Key Infrastructure Certificate and CRL profile and comprises extension data comprising one or more identifiers of respective distributors.

3. A method as claimed in claim 1, wherein the application is a Digital Video Broadcasting compliant application and wherein the Service Information of the associated DVB service comprises the application metadata.

4. A method as claimed in claim 3, wherein the association of an identifier with a distributor is managed by the Digital Video Broadcasting (DVB) Project, the identifier comprising the DVB Network ID issued to a respective distributor.

5. A system for selecting a certificate for the authentication of an application associated with a distributor, the system comprising:
a first server and at least one receiver, the first server operable to send certificates to the at least one receiver;
wherein the at least one receiver is operable to:
access application metadata, which metadata comprises an identifier of the distributor;
extract the identifier from the application metadata;
receive certificates, each certificate comprising one or more identifiers of respective distributors;
extract the identifiers from the certificates; and
select a certificate based on a comparison of the identifiers extracted from the application metadata and the certificates.

6. A system as claimed in claim 5 wherein the first server is further operable to send application metadata to the at least one receiver.

7. A system as claimed in claim 5 further comprising a second server operable to send application metadata to the at least one receiver.

8. A system as claimed in claim 5, wherein a respective distributor is a digital TV operator registered with Digital Video Broadcasting Project.

9. A receiver for use in a system for selecting a certificate for the authentication of an application, the receiver comprising:
a store operable to store application metadata;
a first input device operable to receive certificates;
a processor comprising a CPU interconnected to a program store and a data store, the processor configured to:
access application metadata, which metadata comprises an identifier of the distributor;
extract the identifier from the application metadata;
receive certificates, each certificate comprising one or more identifiers of respective distributors;
extract the identifiers from the certificates; and
select a certificate based on a comparison of the identifiers extracted from the application metadata and the certificates.

10. A receiver as claimed in claim 9 wherein the first input device is further operable to receive the application metadata.

11. A receiver as claimed in claim 9, further comprising a second input device operable to receive certificates.

12. A receiver as claimed in claim 11 wherein the second input device comprises a modem operable to receive certificates via a computer network.

13. A receiver as claimed in claim 9 wherein the first input device comprises a DVB compliant tuner.

14. A receiver as claimed in claim 12, wherein the receiver is included in a set top box.

15. (canceled)

16. A software program, embodied in a computer readable medium, when executed by a processor configured for carrying out acts comprising:
accessing application metadata, which metadata comprises an identifier of the distributor;
extracting the identifier from the application metadata;
receiving certificates, each certificate comprising one or more identifiers of respective distributors;
extracting the identifiers from the certificates; and
selecting a certificate based on a comparison of the identifiers extracted from the application metadata and the certificates, wherein, the association of an identifier with a distributor is managed.

17. (canceled)

18. (canceled)

19. (canceled)
